(19) United States
(12) Patent Application Publication
(10) Pub. No.: US 2008/0080532 A1
(43) Pub. Date: Apr. 3, 2008

(54) Methods and apparatus for managing internet communications using a dynamic STUN infrastructure configuration

(76) Inventors: Mark O'Sullivan, Buckinghamshire (GB); Graham Streit, London (GB); Mario Zancan, Surrey (GB)

Correspondence Address: Ryan, Mason & Lewis, LLP, Suite 205, 1300 Post Road, Fairfield, CT, 06824, US

(21) Appl. No.: 11/541,438

(22) Filed: Sep. 29, 2006

(51) Int. Cl. H04L 12/56

(52) U.S. Cl. 370/401

(57) ABSTRACT

Methods and apparatus are provided for managing Internet communications using a dynamic STUN infrastructure configuration (DSIC). A DSIC server manages communications over the Internet by receiving a registration request from a client; instructing the client to perform a discovery procedure, such as a STUN discovery, to evaluate the NAT that the client is behind; receiving results of the discovery procedure; processing the results of the discovery procedure to evaluate the NAT that the client is behind; and instructing the client to employ a session border controller only if the NAT satisfies one or more predefined criteria. A DSIC client registers with the DSIC server; receiving the instruction to perform the discovery procedure; executes the discovery procedure; provides results of the discovery procedure to the DSIC server; and receives an assigned session border controller for SIP communications only if the NAT satisfies one or more predefined criteria.

### FIELD OF THE INVENTION

The present invention relates generally to network communication techniques, and more particularly, to techniques for communicating in the presence of a network address translator (NAT).

### BACKGROUND OF THE INVENTION

In many computer networks, firewalls are employed to prevent unauthorized communications between sections of the computer network. In addition, many computer networks employ a NAT to change the source and/or destination addresses of IP packets as they pass through a router or firewall. NATs are typically employed so that multiple hosts on a private network can access the Internet using a single public IP address. Firewalls and NATs can complicate communication between hosts. For example, if users are behind firewalls, then they often cannot negotiate a connection with each other and are unable to share files.

A number of techniques have been proposed or suggested for addressing NAT and firewall traversal issues. For example, Session Border Controllers (SBCs) are used in a number of VoIP networks to control the signaling and media streams involved in setting up, conducting, and tearing down calls. SBCs are typically placed in the signaling and/or media path between the called and calling parties. In some implementations, both the signaling traffic and the media traffic (such as voice and video) traverse the SBC. Among other benefits, SBCs can overcome some of the NAT and firewall traversal issues for VoIP calls. Private SBCs are often used with firewalls to enable VoIP calls to and from a protected enterprise network. In addition, public VoIP service providers often use SBCs to permit VoIP protocols from private networks with Internet connections using network address translation.

The Simple Traversal of User Datagram Protocol (UDP) (STUN) is a client-server protocol that allows a client behind one or more NATs to determine its public address, the type of NAT that the client is behind and the Internet-side port associated by the NAT with a particular local IP Address/port. This information is used to set up UDP communication between two hosts that are both behind NAT routers. See, e.g., RFC 3489, incorporated by reference herein.

A VoIP device may include a STUN client, which will send a request to a STUN server. The server then provides the STUN client with the public IP address of the NAT router, and the port opened by the NAT to allow incoming traffic into the network. The response also allows the STUN client to determine the type of NAT that is in use, as different types of NATs handle incoming UDP packets differently. Once a client has discovered its external addresses, the client can provide the external address to its peers. If the NATs are full cone NATs, then either side can initiate communication. If the NATs are restricted cone or restricted port cone NATs, both sides must start transmitting together.

While STUN provides an effective discovery tool for accessing the type of NAT that the client is behind, STUN does not resolve the problem of call establishment in all scenarios. A need therefore exists for resolving NAT transversal by doing remote discovery and traffic routing.

### SUMMARY OF THE INVENTION

Generally, methods and apparatus are provided for managing Internet communications using a dynamic STUN infrastructure configuration (DSIC). According to one aspect of the invention, a DSIC server manages communications over the Internet by receiving a registration request from a client; instructing the client to perform a discovery procedure, such as a STUN discovery, to evaluate the NAT that the client is behind; receiving results of the discovery procedure; processing the results of the discovery procedure to evaluate the NAT that the client is behind; and instructing the client to employ a session border controller only if the NAT satisfies one or more predefined criteria.

According to another aspect of the invention, a DSIC client manages communications over the Internet by registering with the DSIC server; receiving an instruction from the DSIC server to perform a discovery procedure to evaluate the NAT that the client is behind; executing the discovery procedure; providing results of the discovery procedure to the DSIC server; and receiving from the DSIC server an assigned session border controller for SIP communications only if the NAT satisfies one or more predefined criteria.

The STUN discovery notification from the DSIC server to the DSIC client can include an address of a STUN server for the STUN discovery. The STUN server is optionally selected from among a plurality of STUN servers using a load balancing technique. Likewise, if a session border controller is required (determined by evaluating the results of the STUN discovery), the notification from the DSIC server to the DSIC client can include an address of the selected session border controller. The session border controller is optionally selected from among a plurality of session border controllers using a load balancing technique. The session border controller is used by the client for incoming and outgoing SIP communications. In a further variation, the client can optionally update the discovery procedure periodically and an allocation of the session border controller to the client can be adjusted based on the updated discovery procedure.

A more complete understanding of the present invention, as well as further features and advantages of the present invention, will be obtained by reference to the following detailed description and drawings.

### BRIEF DESCRIPTION OF THE DRAWINGS

FIG. 1 illustrates an exemplary network environment in which the present invention can operate;

FIG. 2 is a communication sequence diagram in accordance with a Unified Modeling Language (UML) notation, illustrating the communications and other processing performed by the various entities of FIG. 1;

FIG. 3 is a sample table of an exemplary discovery test results database; and

FIG. 4 is an exemplary discovery test analysis table employed by the DSIC Server to determine if an SBC is required for the determined NAT configuration of the DSIC client.

### DETAILED DESCRIPTION

The present invention provides a dynamic STUN infrastructure configuration (DSIC) and a DSIC server that use a remote diagnostic facility to remotely instruct a client to perform a STUN discovery to determine the type of NAT that the client is behind. The results of the STUN discovery are processed by the DSIC server to determine how to establish a connection. If the NAT type is suitable for SIP call establishment, the DSIC server generally records the customer configuration in a database. If the NAT type is not suitable for SIP call establishment, the DSIC server instructs the client to send all packets to a session border controller. The SBC will perform consistency checks between IP address and port numbers for both signaling and media, comparing the SIP packet and IP headers. In this manner, an SBC is employed only when required. According to a further aspect of the invention, the remote control allows the DSIC server to perform load balancing among the STUN servers and SBCs employed for NAT traversal. In addition, the STUN discovery routine can be dynamically or periodically refreshed to address infrastructure changes and load balancing.

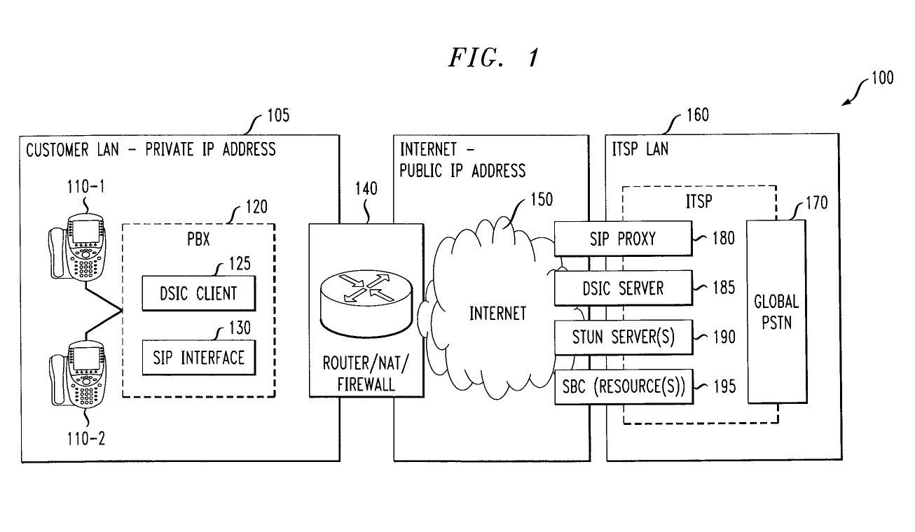

FIG. 1 illustrates an exemplary network environment 100 in which the present invention can operate. As shown in FIG. 1, one or more end user devices 110-1, 110-2, such as VoIP devices, are part of a local area network (LAN) 105, such as an enterprise LAN. The exemplary LAN includes a private branch exchange (PBX) 120 and a firewall/NAT/router 140 that provides an interface for communications over the Internet 150. The end user devices 110 are thus located in a private LAN 105 with a public IP Address, behind a Router/NAT 140.

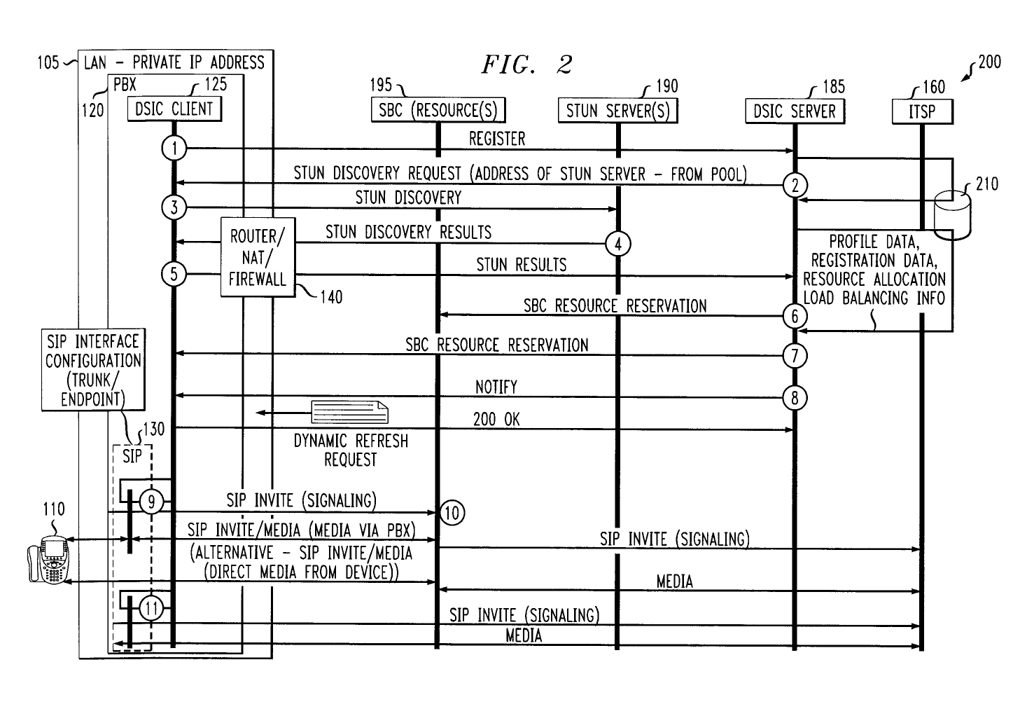

As shown in FIG. 1, the PBX 120 includes one or more DSIC clients 125 and one or more SIP interface 130. The DSIC clients 125 implement the client-side aspects of the present invention, as discussed further below in conjunction with FIG. 2. The SIP interfaces 130 allow the endpoints 120-1, 120-2 to communicate over a SIP network in accordance with the Session Initiation Protocol (SIP).

The enterprise associated with LAN 105 may obtain Internet service from an Internet Service Provider (ITSP) or (ISP). The ITSP implements an ITSP LAN 160, as shown in FIG. 1. The ITSP LAN 160 includes access to the global Public Switched Telephone Network (PSTN) 170, SIP Proxy 180, DSIC server 185, STUN server 190, and one or more Session Border Controllers 195. The ITSP (Internet Service Provider) connects to the Internet 150 using a public internet address to allow these services (SIP Proxy 180, DSIC Server 185, SBC 195) to be consumed. In this manner, these services are connected to the internal infrastructure of the ITSP via their internal private network, for example, using a router/NAT/Firewall (not shown) to protect their backend systems.

FIG. 2 is a UML communication sequence diagram 200, illustrating the communications and other processing performed by the various entities of FIG. 1. As shown in FIG. 1, a DSIC client 125 initially connects to the DSIC server 185 during step 1 using an appropriate protocol, such as SIP or HTTP. The DSIC client 125 registers with the DSIC server 185 and provides data about the local site, such as an identifier, the local IP address and endpoint/trunk manifest, and the transports being utilized (such as UDP, TCP).

The DSIC server 185 then instructs the client to begin STUN discovery during step 2, using a selected instance of a STUN server 190, with the IP Address of the STUN server being supplied from a pool, to ensure the load on any instance of server is not overloaded. The STUN discovery request is discussed further below in a section entitled “STUN data collection.” Generally, a STUN discovery consists of sending requests to external STUN servers on the Public Internet. On receipt of a STUN packet, the STUN server 190 copies what it sees as the originating IP address and port number into the payload of its reply. The observed originating IP address and port number are the Port number and IP address of the intervening NAT/Firewall 140.

In one exemplary implementation, when a DSIC client 125 registers with the DSIC Server 185, the client 125 is allocated a primary STUN server 190 and a secondary STUN server 190. The DSIC server 185 can optionally maintain a STUN registration table and add the client 125 to the STUN registration table. For example, the STUN registration table can maintain a maximum of 10,000 clients per STUN server instance. Thus, if the current number of clients exceeds 10,000, a slot is sought in the next available free table. Once a slot has been found, the IP Address of the selected STUN server 190 is returned to the DSIC client 125 for use in subsequent STUN Discovery requests. A ticket is optionally used and stored in a database 210 to enable tracking of the request and identify subsequent responses.

The DSIC client 125 performs STUN discovery during step 3 using the supplied STUN server IP Address, for example, in accordance with RFC 3489. The STUN server discovery completes during step 4, and the STUN server 190 provides the results to the DSIC client 125.

The DSIC client 125 provides the results to the DSIC server 185 during step 5, for example, using SIP as a transport. The DSIC server 185 extracts the payload containing the STUN results and the original request tracking ticket. The STUN results are analyzed to determine if an SBC resource is required, as discussed further below in a section entitled “STUN Analysis.” The DSIC server 185 maintains profile data, registration data, resource allocation and load balancing data in the database 210.

If it is determined during step 6 that the STUN analysis indicates that the NAT profile of the DSIC client 125 requires an SBC resource, the resource is allocated from a pool of SBC resource. In one preferred implementation, the SBC resource is allocated using a load balancing mechanism. The SBC can be allocated from a pool, using a load balancing algorithm that limits the number of assigned clients to a maximum number, such as 1000 clients per pool. The SBC can be allocated from a table in the database 210 representing one resource pool item. DSIC clients 125 are assigned a pool instance where the number of clients does not exceed 1000. If the maximum number for a given SBC resource is exceeded, the next SBC instance in the pool is searched up to the maximum number of pools. The usage can be analyzed along with the percentage of customer profiles requiring SBC resource to help capacity planning.

During step 7, the DSIC server 185 sends the DSIC client 125 a payload containing a profile, and a specified SBC resource to utilize, if required. This data is then used by the DSIC client 125 for subsequent incoming/outgoing SIP sessions. The DSIC techniques described herein should be executed before a SIP trunk registration to enable an adjustment of parameters.

The DSIC server 185 can optionally periodically send notification requests (i.e., a dynamic refresh request) to the DSIC client 125 during step 8, to have the DSIC client again perform the STUN discovery of step 3 and provide updates to the DSIC server 185. In this manner, resources can be adjusted between pools being managed by the DSIC server 185. This mechanism is optionally used to probe and respond to dynamic changes in the environment.

In this manner, if there is a change in the environment, such as a customer changing their NAT, the resources can be reallocated to make effective use and enable additional resources to be made available. The profile of the NAT is available for analysis, to help with capacity planning, and can be used to differentiate between different sectors.

During step 9, a SIP session is initiated by an endpoint 110 in an environment where the STUN discovery indicated that an SBC is required. The SIP interface 130 is configured to use the IP Address/port of the SBC 195, as instructed by the DSIC server 185 via the DISC client 125. A SIP invite message is first sent to the selected SBC 195. The SBC 195 will send a SIP invite message to the ITSP 160 and the SBC 195 will change the signaling and media packets, as required, to enable successful traversal through the NAT 140 to the ITSP 160, to support incoming and outgoing sessions. During step 10, both the signaling and media information go via the SBC 195. Among other functions, the SBC 195 translates the IP Address/Ports between the site system and the ITSP.

In one exemplary scenario, the endpoint 110 can communicate directly with the PBX 120 in the case of a non-SIP phone. When communicating directly with the PBX 120, the PBX 120 converts the media and handles the SIP communication via a trunk interface, in a known manner. If the endpoint 110 is a SIP device, however, the endpoint 110 may still connect via the PBX 120, where the signaling and media are handled and resent via the SIP trunk. It is noted that the SIP signaling information is sent via the PBX 120 and SIP trunk. The media information, however, is sent directly, as per the configuration of the DSIC client 125.

During step 11, a SIP session is initiated by an endpoint 110 in an environment where the STUN discovery indicated that an SBC is not required, and can proceed in a conventional manner.

### STUN Data Collection

A STUN request typically specifies the following parameters: response-address, change IP flag and change Port flag. The STUN server 190 will reply to the IP and port number specified in the response-address field. If that field is not present, then the server 190 will send its response to the IP and port number from which the request was received.

If the change IP and change Port flags are not set, the STUN server 190 responds from the IP address and port number that the initial packet was sent to (i.e., the source of the reply matches the destination that the request was sent to). If the change IP flag is set, the server 190 replies from a different IP address. If the change port flag is set, the server replies from a different port number.

The STUN response from the STUN server 190 to the DSIC client 125 contains the following information:

mapped-address—the IP address and port number of the client 125 as seen by the STUN server 190;

changed-address—the IP address that would be the source of reply if the request had the change IP flag set; and

source-address—the IP and port where the STUN response was sent from.

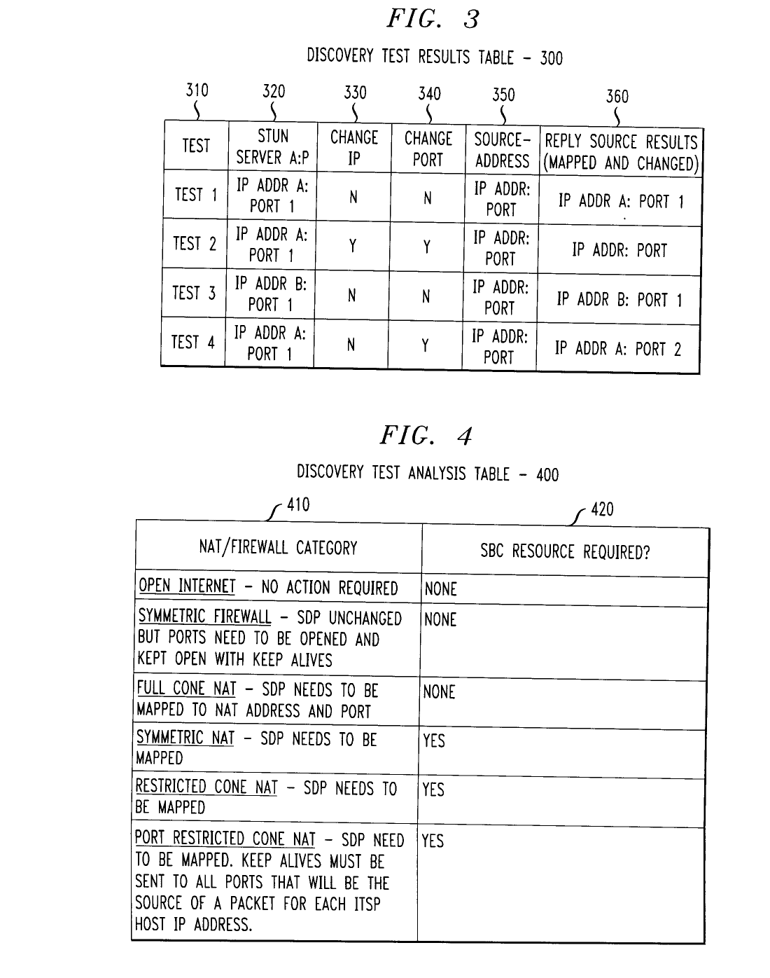

FIG. 3 is a sample table of an exemplary discovery test results database 300. In one exemplary implementation, four tests are performed to characterize the NAT/Firewall 140 that the client 125 is situated behind. The test plan is sent to the DSIC Client 125, which executes the test and collects the results in the table 300.

As shown in FIG. 3, for each of the tests, identified in field 310, the discovery test results database 300 identifies the STUN Server 190, for example, by IP address and port number, in field 320, the Change IP flag in field 330, the Change Port flag in field 340, the source-address in field 350 and the Reply Source Results in field 360. As each test is executed, the results from the STUN Server 190 are recorded in the Reply Source Results field of the table 300.

The results of the STUN discovery test are passed, for example, as an XML encoded document to the DSIC Server 185 during step 5 for analysis.

The following explanation discusses how the test plan can be executed and the meaning of the data that the DSIC Server 185 will attribute to the results. As previously indicated, four tests (Tests 1 through 4) are performed in the exemplary embodiment to characterize the NAT/Firewall 140.

Initially, Test 1 is run by Sending a STUN request to IP address A with Change IP number and Change port number flags set to “no.” If no reply is received, the client 125 is behind a firewall that is blocking UDP. If a reply is received, Test 2 is executed.

During Test 2, a request is sent with the change IP address and Change port number flags set to “yes.” If a reply is received from Test 2 and the mapped-address in Test 1 matches the address of the PBX 120, the solution knows it is freely reachable from any public internet address (unblocked). If a reply from Test 2 is not received and the mapped-address in Test 1 matches the address of the PBX 120, the PBX 120 knows that it is behind a symmetric firewall (i.e., the address of the PBX 120 is on the open Internet but only packet from destinations that it has sent to can send to it, providing a hole is maintained in the firewall 140). If a reply is received from Test 2 and the mapped-address in Test 1 does not match the address if the PBX 120, the PBX 120 knows it is behind a Full Cone NAT. If a reply from Test 2 is not received and the mapped-address in Test 1 does not match the address of the PBX 120, Test 3 is executed.

During Test 3, the PBX 120 sends a request to the second STUN server 190 with the change IP Number and Change Port number flags set to “no.” If the mapped-address field in Test 3 does not match the mapped address in Test 1, the IP Office is behind a symmetric NAT. If the mapped-address field in Test 3 matches the mapped address in Test 1, the PBX 120 runs Test 4.

During Test 4, the PBX 120 sends a request to the first STUN server 190 with the change IP flag set to “no” and the change port flag set to “yes.” If a response is received, the PBX 120 is behind a Restricted NAT. If no response is received, the PBX is behind a Port restricted NAT.

### STUN Analysis

As previously indicated, the results of the STUN discovery test are passed, for example, as an XML encoded document to the DSIC Server 185 during step 5 for analysis.

FIG. 4 is an exemplary discovery test analysis table 400 employed by the DSIC Server to determine if an SBC is required for the NAT configuration of the DSIC client. As shown in FIG. 4, the table 400 identifies a number of different potential NAT/Firewall categories in Field 410 and a corresponding indication in field 420 of whether an SBC is required for the NAT/Firewall configuration.

While the figures herein show an exemplary sequence of steps, it is also an embodiment of the present invention that the sequence may be varied. Various permutations of the algorithms are contemplated as alternate embodiments of the invention.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

We claim:

1. A method for managing communications over the Internet, comprising:
receiving a registration request from a client;
instructing said client to perform a discovery procedure to evaluate a NAT that the client is behind;
receiving results of said discovery procedure;
processing said results of said discovery procedure to evaluate said NAT that said client is behind; and
instructing said client to employ a session border controller only if said NAT satisfies one or more predefined criteria.

2. The method of claim 1, wherein said discovery procedure is a STUN discovery.

3. The method of claim 2, wherein said step of instructing said client to perform a discovery procedure provides said client with an address of a STUN server for said STUN discovery.

4. The method of claim 3, wherein said STUN server is selected from among a plurality of STUN servers using a load balancing technique.

5. The method of claim 1, wherein said step of instructing said client to employ a session border controller provides said client with an address of a session border controller.

6. The method of claim 5, wherein said session border controller is selected from among a plurality of session border controllers using a load balancing technique.

7. The method of claim 5, wherein said client uses said session border controller for incoming and outgoing SIP communications.

8. The method of claim 1, further comprising the step of notifying said client to update said discovery procedure.

9. The method of claim 8, further comprising the step of adjusting an allocation of said session border controller to said client based on said updated discovery procedure.

10. A method performed by a client for communicating over the Internet, comprising:
registering with a server that manages communications over the Internet;
receiving an instruction from said server to perform a discovery procedure to evaluate a NAT that the client is behind;
executing said discovery procedure;
providing results of said discovery procedure to said server; and
receiving from said server an assigned session border controller for SIP communications only if said NAT satisfies one or more predefined criteria.

11. The method of claim 10, wherein said discovery procedure is a STUN discovery.

12. The method of claim 11, wherein said instruction to perform a discovery procedure comprises an address of a STUN server for said STUN discovery.

13. The method of claim 12, wherein said STUN server is selected from among a plurality of STUN servers using a load balancing technique.

14. The method of claim 10, wherein said instruction to employ a session border controller comprises an address of a session border controller.

15. The method of claim 14, wherein said session border controller is selected from among a plurality of session border controllers using a load balancing technique.

16. The method of claim 14, wherein said session border controller is used for incoming and outgoing SIP communications.

17. The method of claim 10, further comprising the step of receiving a notification to update said discovery procedure.

18. The method of claim 17, wherein an allocation of said session border controller is adjusted based on said updated discovery procedure.

19. A system for managing communications over the Internet, comprising:
a memory; and
at least one processor, coupled to the memory, operative to:
receive a registration request from a client;
instruct said client to perform a discovery procedure to evaluate the NAT that the client is behind;
receive results of said discovery procedure;
process said results of said discovery procedure to evaluate said NAT that said client is behind; and
instruct said client to employ a session border controller only if said NAT satisfies one or more predefined criteria.

20. A system performed by a client for communicating over the Internet, comprising:
a memory; and
at least one processor, coupled to the memory, operative to:
register with a server that manages communications over the Internet;
receive an instruction from said server to perform a discovery procedure to evaluate the NAT that the client is behind;
execute said discovery procedure;
provide results of said discovery procedure to said server; and
receive from said server an assigned session border controller for SIP communications only if said NAT satisfies one or more predefined criteria.
